(19) United States
(12) Patent Application Publication
(10) Pub. No.: US 2007/0229254 A1
(43) Pub. Date: Oct. 4, 2007

(54) SAFETY ALARM SYSTEM

(75) Inventor: GA-LANE CHEN, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/565,877

(22) Filed: Dec. 1, 2006

(30) Foreign Application Priority Data
Mar. 31, 2006 (CN) 200610060147.5

(51) Int. Cl. G08B 21/00; H04N 7/18; G08B 1/00

(52) U.S. Cl. 340/540; 348/143; 340/531

(57) ABSTRACT

A safety alarm system includes an imaging module configured for capturing images of surroundings of a user and producing an image signal associated with the images; a signal transmitting module electronically connected to the imaging module; and an alarm generating module electronically connected to the signal transmitting module, the alarm generating module being configured for generating an alarm signal, the transmitting module being configured for receiving the image signal and the alarm signal and sending the image signal and the alarm signal to a receiving terminal.

### BACKGROUND

1. Technical Field

The present invention relates to a safety alarm system for real-time monitoring.

2. Discussion of Related Art

A monitor (or closed circuit television—CCTV) camera is a kind of imaging apparatus including a camera and a rotatable table. This monitor camera is capable of rotating horizontally (i.e., panning) while rotating vertically (i.e., tilting) by movement of rotatable tables. The monitor camera can rotate through 360 degrees without limitation in the horizontal, while rotating in an angular range between 0 degrees and 90 degrees, that is, from a horizontal direction to a vertical direction, in the vertical. Thus a controller can use this monitor camera to film at a desired angle or in a desired direction

However, the monitor cameras are generally fixed in place, and the monitor cameras cannot work during continuous movement.

Therefore, what is needed is a system capable of real-time monitoring during continuous movement.

### SUMMARY

In one embodiment of the present invention, a safety alarm system is provided. The safety alarm system include: an imaging module configured for capturing images of surroundings of a user and producing an image signal associated with the images; a signal transmitting module electronically connected to the imaging module; and an alarm generating module electronically connected to the signal transmitting module, the alarm generating module being configured for generating an alarm signal, the transmitting module being configured for receiving the image signal and the alarm signal and sending the image signal and the alarm signal to a receiving terminal.

Detailed features of the present safety alarm system will become more apparent from the following detailed description and claims, and the accompanying drawings.

### BRIEF DESCRIPTION OF THE DRAWINGS

Many aspects of the present safety alarm system can be better understood with reference to the following drawings. The components in the drawings are not necessarily drawn to scale, the emphasis instead being placed upon clearly illustrating the principles of the present safety alarm system. Moreover, in the drawings, like reference numerals designate corresponding parts throughout the several views, wherein:

FIG. 1 is a schematic view of a safety alarm system according to an exemplary embodiment; and

FIG. 2 is a schematic view of an imaging module of the safety alarm system according as shown in FIG. 1.

### DETAILED DESCRIPTION OF THE PREFERRED EMBODIMENTS

Reference will now be made to the drawings to describe the preferred embodiments of the safety alarm system, in detail.

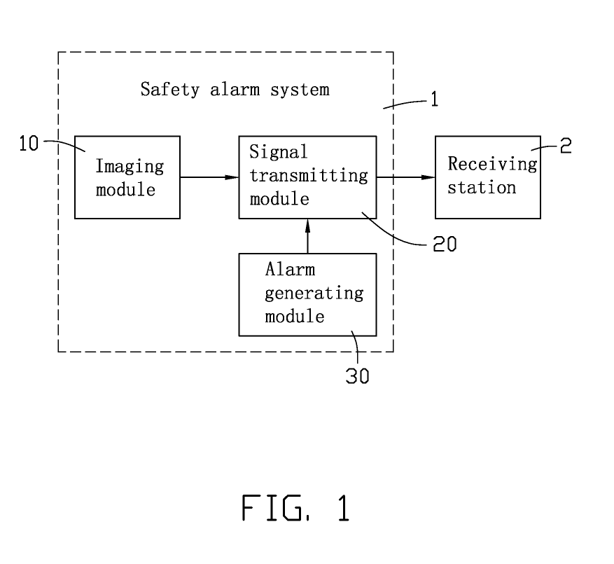

Referring now particularly to FIG. 1, where a safety alarm system 1 according to an embodiment of the present invention is shown. The safety alarm system 1 includes an imaging module 10, a signal transmitting module 20 and an alarm generating module 30.

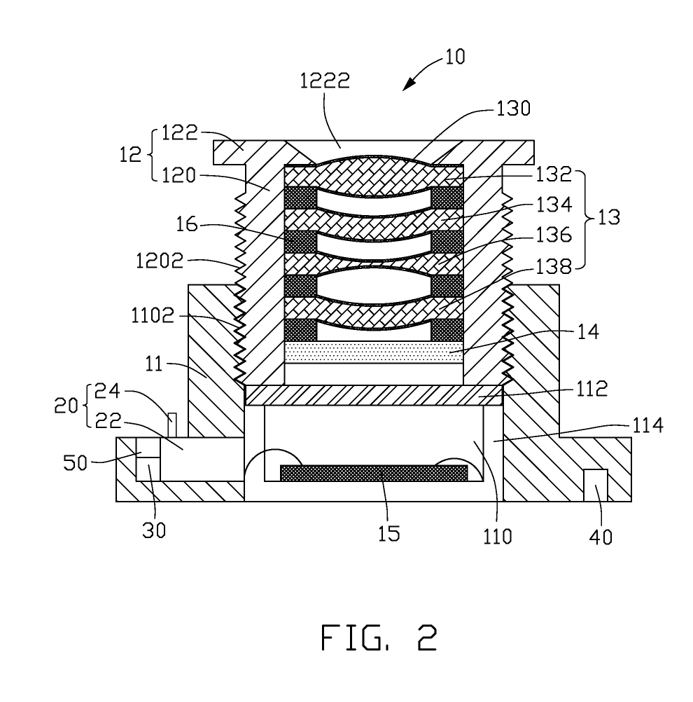

The imaging module 10 is configured for capturing images of surroundings of a user and producing an image signal. Referring to FIG. 2, the imaging module 10 includes a holder 11, a barrel 12, a lens assembly 13, a filter 13 and an imaging sensor 15.

The holder 11 is configured for holding the barrel 12. The holder 11 has a chamber 110 formed in its interior. The chamber 110 has internal thread 1102 formed on its sidewall. Preferably, the opening 110 further receives a substrate 114 at the bottom. The substrate 114 can be used for holding the image sensor 15. The substrate 114 can be made of ceramic.

The barrel 12 is configured for receiving the lens assembly 13 and the filter 14. The barrel 12 includes a main body 120 and a front portion 122. The main body 120 is cylindrical in shape. The main body 120 has an external thread 1202 formed thereon in a manner such that the barrel 12 is received in the holder 11 by screw thread fit. The front portion 122 is at one end of the main body 120 and defines a funnel hole 1222 for controlling incident angle of entering rays and avoiding incidence of stray light.

The lens assembly 13 is configured for picking up images. The lens assembly 13 is received in the main body 120 and resists to the front portion 122. The lens assembly 13 includes a plurality of aspheric lenses. Each of the aspheric lenses has an antireflective film 130 formed on the surface. The aspheric lenses can be plastic lenses, or partially plastic lenses, and the other glass-molding lenses. The antireflective film 130 includes silicon dioxide layers and titanium dioxide layers. Preferably, the silicon dioxide layers and titanium dioxide layers are alternately formed on the surface of the aspheric lenses one on another. In an exemplary embodiment, the lens assembly 13 includes four aspheric lenses 132, 134, 136 and 138. The aspheric lenses 132, 134 and 136 are plastic lenses, and the aspheric lens 138 is glass-molding lens. Each of the aspheric lenses 132, 134, 136 and 138 has an antireflective film 130 formed on the surface. Generally, there will be a spacer 16 disposed between the neighboring aspheric lenses in order to prevent the neighboring aspheric lenses from impacting each other.

The filter 14 is configured for cutting lights having some predetermined wave lengths. The filter 14 is received in the main body 120 and placed at one end of the main boy 120 opposite to the front portion 122. The filter 14 can be an infrared filter that includes a glass substrate and a plurality of silicon dioxide layers and titanium dioxide layers alternately formed on the glass substrate. Preferably, the total number of the silicon dioxide layers and titanium dioxide layers is 36. Advantageously, a spacer 16 can be disposed between the aspheric lens 138 and the filter 14 in order to prevent them from impacting each other.

The image sensor 15 is configured for capturing and converting the images into an image signal. The image sensor 15 is disposed on the substrate 14. The image sensor 15 can be a charge coupled device (CCD) sensor or a complementary metal-oxide semiconductor (CMOS) sensor. The image sensor 15 can have different sizes according to the number of the aspheric lenses. For example, the size of the image sensor 15 can be approximately 1/7˜¼ inches and preferably ⅙˜⅕ inches when there are two aspheric lenses, the size of the image sensor 15 can be approximately ¼˜⅓ inches when there are three aspheric lenses, and the size of the image sensor 15 can be approximately ¼˜½ inches, and should preferably be ⅓˜½ inches when there are four aspheric lenses. Preferably, a transparent plate 112 is received in the opening 110 of the holder 11. The transparent plate 112 is configured (i.e., structured and arranged) for preventing the image sensor 15 from becoming polluted.

The signal transmitting module 20 is positioned on the holder 11 and electronically connected to the imaging module 10. The signal transmitting module 20 includes a radio frequency transmitting device 22 for transmitting the image signals to a receiving terminal 2 (for example a police station). Preferably, the signal transmitting module 20 further includes a transmitting antenna 24 for enhancing transmission capabilities of the signal transmitting module 20.

The alarm generating module 30 is configured on the holder 11 and electronically connected to the signal transmitting module 20. The alarm generating module 30 includes a trigger module. The trigger module can be operated remotely and can trigger the alarm generating module 30 to produce an alarm signal. The alarm generating module 30 can output the alarm signal to the signal transmitting module 20, and the alarm signal will be transmitted to the receiving station 2 by the signal transmitting module 20. Preferably, the alarm generating module 30 further includes a speaker for generating an alarm sound after receiving the alarm signal.

Preferably, the safety alarm system 1 further includes a media player 40, for example an mp3, or an mp4 player etc. The media player 40 can be configured on the holder 11 for playing media documents. The media player 40 can also has flash memory card for recording the media documents.

Preferably, the safety alarm system 1 further includes a global positioning system 50. The global positioning system 50 can be attached to the holder 11 for determining a location of the user who takes the safety alarm system 1. During detection, the global positioning system 50 receives pseudo-random codes and data information from different satellites, calculates distances between the global positioning system 50 and each of the satellites, and then determines the location of the global positioning system 50. The location can also be transmitted to the receiving terminal 2 by the signal transmitting module 20.

The above-mentioned safety alarm system 1 captures images and produces image signals using the imaging module 10, transmits the image signals using the signal transmitting module 20, generates an alarm signal using the alarm generating module 30 after being remotely triggered and transmits the alarm signals to the receiving terminal 2.

The safety alarm system 1 can be used for real-time monitoring during continuous movement. The safety alarm system 1 can be placed in hats, glasses, collars, earrings, necklaces, neckcloths, pockets, straps etc. and can be used for personal protection and in police surveillance. In case of emergency, people equipped with the safety alarm system 1 can record the scene for evidence and trigger the alarm generating module 20 to call for assistance.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A safety alarm system comprising:
an imaging module configured for capturing images of surroundings of a user and producing an image signal associated with the images;
a signal transmitting module electronically connected to the imaging module; and
an alarm generating module electronically connected to the signal transmitting module, the alarm generating module being configured for generating an alarm signal, the transmitting module being configured for receiving the image signal and the alarm signal and sending the image signal and the alarm signal to a receiving terminal.

2. The safety alarm system according to claim 1, wherein the imaging module comprises a lens assembly and a filter;

3. The safety alarm system according to claim 2, wherein the lens assembly comprises a plurality of aspheric lenses;

4. The safety alarm system according to claim 3, wherein the aspheric lenses each have an antireflective film formed thereon.

5. The safety alarm system according to claim 4, wherein the antireflective film comprises a plurality of silicon dioxide layers and a plurality of titanium dioxide layers.

6. The safety alarm system according to claim 5, wherein the silicon dioxide layers and the titanium dioxide layers are alternately formed on surfaces of the aspheric lenses one on another.

7. The safety alarm system according to claim 2, wherein the filter is an infrared filter that includes a glass substrate with a plurality of silicon dioxide layers and titanium dioxide layers formed in an alternating fashion thereon.

8. The safety alarm system according to claim 2, wherein the lens assembly comprises an image sensor for capturing and converting the images into the image signal.

9. The safety alarm system according to claim 8, wherein the image sensor is selected from a group consisting of charge coupled devices (CCD) and complementary metal-oxide semiconductors (CMOS).

10. The safety alarm system according to claim 1, wherein the signal transmitting module comprises a radio frequency transmitting device and a transmitting antenna.

11. The safety alarm system according to claim 1, further comprising a trigger module for triggering the alarm generating module to produce the alarm signal.

12. The safety alarm system according to claim 11, wherein the alarm generating module further comprises a speaker for generating an alarm sound.

13. The safety alarm system according to claim 1, further comprising a media player for playing media documents.

14. The safety alarm system according to claim 1, further comprising a global positioning system for determining a location of the user.
